(19) United States
(12) Patent Application Publication
(10) Pub. No.: US 2025/0324317 A1
(43) Pub. Date: Oct. 16, 2025

(54) SYSTEM AND METHOD FOR MANAGING NETWORK BANDWIDTH FOR SIMULTANEOUS DATA TRANSMISSION TO MULTIPLE WIRELESS DEVICES

(71) Applicant: DISH Network L.L.C., Englewood, CO (US)

(72) Inventor: William Michael Beals, Englewood, CO (US)

(21) Appl. No.: 18/633,280

(22) Filed: Apr. 11, 2024

(51) Int. Cl. H04W 28/02; H04L 47/25

(52) U.S. Cl. CPC H04W 28/0257; H04L 47/25

(57) ABSTRACT

When an access point detects that the access point is to simultaneously transmit data to or receive data from a plurality of devices at respective data rates, the access point determines portions of a total available bandwidth occupied by each of the devices. When the access point determines that the a sum of the portions occupied by all the devices exceeds the total available bandwidth and that a maximum link speed supported by a first device of the plurality of devices is the slowest among all the devices, the access point throttles the data rate of the first device, and transmits data to or receives data from the first device at the throttled data rate and transmits data to or receives data from the remaining devices at their requested data rates.

### TECHNICAL FIELD

The present disclosure relates generally to network communications, and more specifically to a system and method for managing network bandwidth for simultaneous data transmissions between multiple network devices.

### BACKGROUND

Generally, when a data bandwidth of an access point is oversubscribed, data transfer rates for one or more network devices connected to the access point are throttled down so that the total of the data transfer rates provided to the devices does not exceed the total bandwidth supported by the access point. Presently, when the total bandwidth is oversubscribed, access points with native bandwidth and QoS management try to provide similar data transfer rates to all devices without considering that slower devices occupy a much larger portion of the total bandwidth as compared to faster devices for the same or similar data transfer rates. Thus, when the total bandwidth is oversubscribed, data transfer rates of faster devices are throttled down even when they occupy a lesser portion of the total bandwidth. Thus, assigning similar data transfer rates to faster as well as slower devices in an oversubscription condition causes an unfair distribution of bandwidth leading to an overall diminished user experience. In a typical network in which several devices are connected to the access point, a single slower device may cause several faster devices to be throttled leading to an overall diminished user experience.

### SUMMARY

The system and methods implemented by the system as disclosed in the present disclosure provide improved techniques for managing an oversubscribed wireless bandwidth. The disclosed system and methods provide several practical applications and technical advantages. For example, the disclosed system and method provide the practical application of intelligently distributing bandwidth to requesting wireless devices in a wireless network based at least on a maximum link speed supported by each wireless device. As described in accordance with embodiments of the present disclosure, a wireless access point determines the portions of a total bandwidth supported by the access point that are occupied by a plurality of wireless devices connected to the access point. The access point determines whether the total supported bandwidth is oversubscribed based at least on the portions of the total bandwidth occupied by the wireless devices. In response to determining that the total supported bandwidth is oversubscribed, the access point identifies a particular wireless device that supports the lowest maximum link speed and throttles down a data transfer rate associated with the particular wireless device to bring the overall bandwidth needed to communicate with all requesting wireless devices below the total supported bandwidth.

Thus, the disclosed system and method intelligently identify the slowest wireless device in the network. Throttling down the data rate of a slow device is far more effective in solving the oversubscription issue as compared to throttling down several faster devices that occupy lesser portions of the available bandwidth. Determining which one or more wireless devices to throttle based on the link speeds supported by the wireless devices helps alleviate the oversubscription issue without affecting too many devices on the wireless network and thus improve overall user experience on the wireless network.

Throttling down data rate of one or more slower devices that support lower link speeds allows the access point to transmit to or receive from a plurality of faster devices at much faster data rates. This improves the overall data transfer rates and data throughput of the wireless network, thus improving the performance of several wireless devices in the wireless network and improving the overall performance of the wireless network.

Thus, the disclosed system and method generally improves the technology associated with wireless networks.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a system in accordance with embodiments of the present disclosure; and

FIG. 2 illustrates an example distribution of bandwidth between wireless devices by the access point, in accordance with one or more embodiments of the present disclosure; and

FIG. 3 is a flowchart of an example method 300 for managing network bandwidth, in accordance with embodiments of the present disclosure.

### DETAILED DESCRIPTION

### System Overview

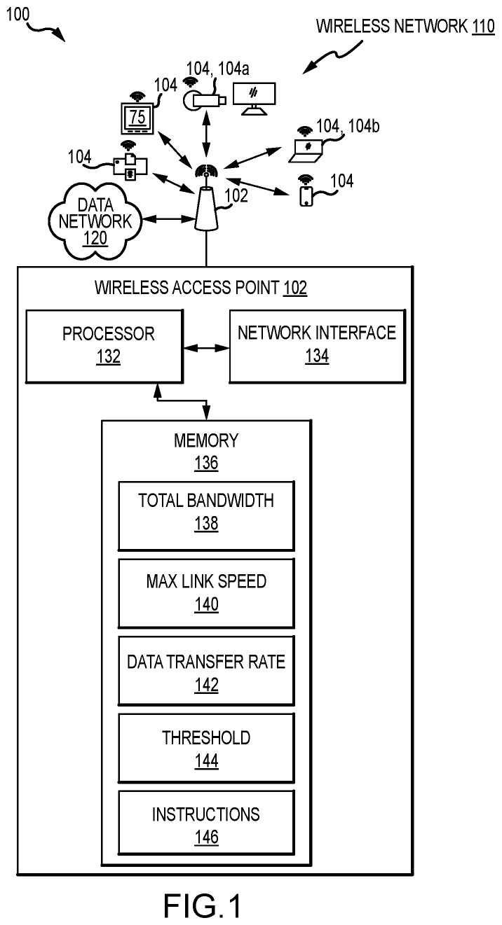

FIG. 1 illustrates an example system 100, in accordance with embodiments of the present disclosure. As shown in FIG. 1, system 100 may include a wireless network 110 including a wireless access point 102 and a plurality of wireless devices 104 capable of wirelessly communicating with the wireless access point 102, and a data network 120. In one embodiment, the wireless access point 102 is configured to connect each wireless device 104 to the data network 120. The data network 120 may include a private network such as a Local Area Network (LAN). Additional or alternatively, the data network 120 may include the Internet. In certain embodiments, the wireless access point 102 may connect to the data network 120 using a wired connection such as ethernet, coaxial cable, optical fiber etc.

It may be noted that while embodiments of the present disclosure are described with reference to a wireless network 110 including a wireless access point 102 wireless communicating with wireless devices 104, a person having ordinary skill in the art may appreciate that the disclosed embodiments apply to wired networks (e.g., Multimedia over Coaxial Alliance (MoCA)) including an access point communicating with network devices using wired connections. Further, it may be noted that while certain embodiments of the present disclosure are described with reference to data transmission from the wireless access point 102 to the wireless devices 104, a person having ordinary skill in the art may appreciate that the disclosed embodiments apply to data transmissions between the wireless access point 102 and the wireless devices 104 regardless of the direction of data transmission between the devices.

Generally, a wireless access point (e.g., wireless access point 102) is a networking device that allows wireless-capable devices (e.g., wireless devices 104) to connect to a wired network (e.g., data network 120). Examples of a wireless access point 102 may include, but are not limited to, a root access point that is connected directly to a wired network (e.g., data network 120) providing a wireless connection point to wireless devices 104, or a repeater access point (e.g., a mesh extender) that extends the range of a wireless network by forwarding data received from another access point that is connected to a wired network. In certain embodiments, the wireless access point 102 may implement a wireless router. The wireless network 110 may support and operate according to one or more wireless communications standards/protocols including, but not limited to the Wireless LAN (WLAN)/Wi-Fi protocols such as the 802.11 family of standards. It may be noted that while embodiments of the present disclosure may be described with reference to WLAN and Wi-Fi protocols, a person having ordinary skill in the art may appreciate that the disclosed embodiments apply to any wireless communication standard/protocol that may be used for communication in the wireless network 110.

A maximum link speed 140 that can be achieved on a wireless connection between the wireless access point 102 and a particular wireless device 104 generally is a function of several factors including, but not limited to the capabilities of the access point 102, the capabilities of the particular wireless device 104, and/or radio conditions experienced by the particular wireless device 104. Capabilities of the access point 102 may include, but are not limited to, one or more wireless protocols (e.g., 802.11ac, 802.11ax etc.) supported by the access point 102, one or more channel frequencies (e.g., 2.4 GHz, 5 GHz etc.) supported by the access point 102, number of antennas used by the access point 102, and/or a total bandwidth 138 supported by the access point 102. Generally, the term “bandwidth” refers to a data transfer rate. The total bandwidth 138 supported by the access point 102 is a measure of the maximum data transfer rate or capacity of the access point 102 that is generally measured in bits per second (bps), megabits per second (Mbps) or gigabits per second (Gbps). Similarly, capabilities of a particular wireless device 104 includes, but is not limited to, one or more wireless protocols (e.g., 802.11ac, 802.11ax etc.) supported by the wireless device 104, one or more channel frequencies (e.g., 2.4 GHz, 5 GHz etc.) supported by the wireless device 104, number of antennas used by the wireless device 104, and/or a maximum bandwidth supported by the wireless device 104. The maximum bandwidth supported by the wireless device 104 is a measure of the maximum data transfer rate supported by the wireless device 104.

As networking technology improves, newer networking standards and protocols are being introduced that support higher data transfer rates as compared to older standards and protocols. Often users upgrade access points 102 (e.g., wireless routers) in their wireless network 110 to newer and faster access points 102, but do not upgrade all wireless devices 104 in the wireless network 110 as it may be cost prohibitive to upgrade all wireless devices 104 at once. Often, users upgrade their wireless devices 104 one by one at different points in time, which means that different wireless devices 104 in the wireless network 110 may support different generations of wireless protocols and may have different capabilities (e.g., supported channel, data rate, antennas etc.). Thus, it is common for a wireless network 110 to have devices (e.g., access point 102, wireless devices 104) having mismatched capabilities. Generally, a wireless access point 102 (e.g., wireless router) is designed to be backward compatible, and thus, supports older generations of wireless protocols. This allows a newer access point 102 to communicate with older devices.

When two devices with mismatched capabilities communicate in a wireless network 110 a Least Common Capability (LCC) between the devices is selected for the communication. For example, when a faster access point 102 communicates with a slower wireless device 104, the two devices communicate according to the capabilities of the slower device. For example, when the faster access point 102 can support a data transfer rate of 400 Mbps, but the slower wireless device 104 can only support 25 Mbps, the two devices communicate at a maximum link speed of 25 Mbps. Thus, although the access point 102 supports much faster data transfer rates, it is limited to communicating with the slower wireless device 104 at the slower data transfer rate supported by the wireless device 104. However, the same access point 102 can communicate with other newer and faster wireless devices 104 in the wireless network 110 at faster speeds. As a slower wireless device 104 communicates with the access point 102 at a slower data transfer rate as compared to a faster wireless device 104, generally it takes longer for the access point 102 to transmit a certain amount of data to the slower wireless device 104 as compared to transmitting the same amount of data to the faster wireless device 104. Thus, assuming that both wireless devices 104 are experiencing similar radio conditions (e.g., similar signal strength from the wireless access point 102), the slower wireless device 104 occupies a larger portion of the available bandwidth as compared to the faster wireless device 104 for the same amount of data transfer.

In some cases, certain access points 102 (e.g., wireless routers) include native bandwidth and Quality of Service (QOS) management to fairly distribute the available/supported bandwidth of the access point 102 to the various wireless devices 104 in the wireless network 110. Generally, when the total supported bandwidth 138 of the access point 102 is not oversubscribed, the access point 102 assigns whatever data transfer rates 142 requested by the individual wireless devices 104. Oversubscription of the total bandwidth 138 is a condition when the data transfer rates 142 simultaneously requested by several wireless devices 104 exceeds the total supported bandwidth 138 of the access point 102. In such a case, data transfer rates 142 for one or more wireless devices 104 are throttled down so that the total of the data transfer rates provided to the wireless devices 104 does not exceed the total bandwidth 138 supported by the access point 102. Presently, when the total bandwidth 138 is oversubscribed, access points 102 with native bandwidth and QoS management try to provide similar data transfer rates to all wireless devices 104 without considering that slower wireless devices 104 support slower link speeds and thus occupy a much larger portion of the total bandwidth 138 as compared to faster wireless devices 104 for the same or similar data transfer rates 142.

For example, when the maximum link speed supported by a wireless network router is 400 Mbps, but a wireless streaming device can only support a maximum link speed of 25 Mbps, the router can transmit to the streaming device at a maximum link speed of 25 Mbps. This means that if the router transmits to the streaming device at 25 Mbps, the streaming device occupies 100% of the router's total supported bandwidth leaving no bandwidth for other devices on the wireless network serviced by the router. In one example, when the streaming device requests that data be transmitted to the streaming device at a data rate of 15 Mbps, the 15 Mbps transmission occupies (15/25)×100=60% of the total available bandwidth. In another example, a second faster wireless device that supports a maximum link speed of 150 Mbps and requests that data be transmitted to the second device at the same data rate of 15 Mbps, the 15 Mbps transmission to the second device occupies (15/150)×100=10% of the total bandwidth. These two examples demonstrate that, because of the slower link speed, a slower device may occupy a significant portion of the total supported bandwidth leaving little bandwidth for other faster devices on the network.

In present systems, no consideration is given to the maximum link speeds supported by particular wireless devices 104 which changes based on the capabilities of the wireless devices 104. As described above, a slower device that supports a slower maximum link speed occupies a larger portion of the available bandwidth as compared to a faster device for the same data transfer rate. Thus, when the total bandwidth 138 is oversubscribed, data transfer rates 142 of faster devices are throttled down even when they occupy a lesser portion of the total bandwidth. Thus, assigning similar data transfer rates 142 to faster as well as slower devices in an oversubscription condition, causes an unfair distribution of bandwidth leading to an overall diminished user experience. In a typical network in which several wireless devices 104 are connected to the access point 102, a single slower wireless device 104 may cause several faster wireless devices 104 to be throttled leading to an overall diminished user experience. With access points 102 getting faster and having to communicate with older devices as a result of backward compatibility, the portion of the bandwidth occupied by devices is becoming more critical and this situation is getting worse.

Embodiments of the present disclosure describe improved techniques for managing an oversubscription of the total bandwidth 138 supported by an access point 102. As described in more detail below, when the total bandwidth supported by the wireless access point 102 is oversubscribed, the wireless access point 102 may be configured to distribute bandwidth to requesting wireless devices 104 based at least on a maximum link speed supported by each wireless device 104.

As shown in FIG. 1, the wireless access point 102 may include a processor 132, a memory 136, and a network interface 134. The wireless access point 102 may be configured as shown in FIG. 1 or in any other suitable configuration.

The processor 132 includes one or more processors operably coupled to the memory 136. The processor 132 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 132 may be a programmable logic device, a microcontroller, a microprocessor, or any suitable combination of the preceding. The processor 132 is communicatively coupled to and in signal communication with the memory 136. The one or more processors are configured to process data and may be implemented in hardware or software. For example, the processor 132 may be 8-bit, 16-bit, 32-bit, 64-bit or of any other suitable architecture. The processor 132 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

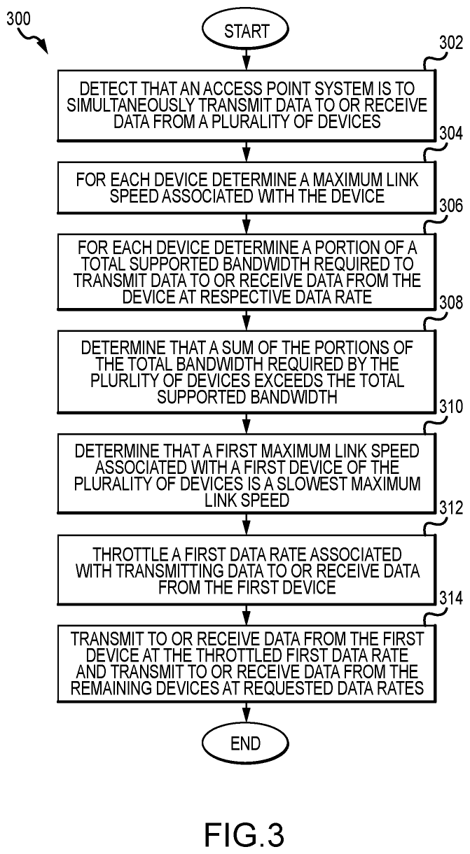

The one or more processors are configured to implement various instructions, such as software instructions. For example, the one or more processors are configured to execute instructions 146 to implement the wireless access point 102. In this way, processor 132 may be a special-purpose computer designed to implement the functions disclosed herein. In one or more embodiments, the wireless access point 102 is implemented using logic units, FPGAs, ASICS, DSPs, or any other suitable hardware. The wireless access point 102 is configured to operate as described with reference to FIG. 3. For example, the processor 132 may be configured to perform at least a portion of the method 300 as described in FIG. 3.

The memory 136 comprises a non-transitory computer-readable medium such as one or more disks, tape drives, or solid-state drives, and may be used as an over-flow data storage device, to store programs when such programs are selected for execution, and to store instructions and data that are read during program execution. The memory 136 may be volatile or non-volatile and may comprise a read-only memory (ROM), random-access memory (RAM), ternary content-addressable memory (TCAM), dynamic random-access memory (DRAM), and static random-access memory (SRAM).

The memory 136 is operable to store a total bandwidth 138 supported by the wireless access point 102, maximum link speeds 140 supported by each wireless device 104, data transfer rates 142 between the wireless access point 102 and each wireless device 104, a threshold bandwidth (e.g., threshold data transfer rate) 144, and instructions 146. The instructions 146 may include any suitable set of instructions, logic, rules, or code operable to execute the wireless access point 102.

The network interface 134 is configured to enable wired and/or wireless communications. The network interface 134 is configured to communicate data between the wireless access point 102 and other devices, systems, or domains (e.g., wireless devices 104). For example, the network interface 134 may comprise a Wi-Fi interface, a LAN interface, a WAN interface, a modem, a switch, or a router. The processor 132 is configured to send and receive data using the network interface 134. The network interface 134 may be configured to use any suitable type of communication protocol as would be appreciated by one of ordinary skill in the art.

It may be noted that each wireless device 104, may be implemented similar to the wireless access point 102. For example, a wireless device 104 may include a processor and a memory storing instructions to implement the respective functionality of the wireless device 104 when executed by the processor.

The wireless access point 102 may be configured to determine a maximum link speed 140 that may be achieved between the access point 102 and a particular wireless device 104a. The maximum link speed 140 represents an estimated maximum speed of data exchange that can be achieved between the access point 102 and a wireless device 104. In certain embodiments, before actual data transfer takes place, the access point 102 and the a wireless device 104a negotiate the maximum link speed 140 between the access point 102 and the a wireless device 104a. Different wireless devices 104 negotiate different maximum link speeds 140 with the wireless access point 102 depending on several parameters including, but not limited to, wireless protocol used by the wireless device, supported channel frequency, number of antennas, and/or radio conditions (e.g., signal strength from the access point 102) at the wireless device 104. As described above, a least common capability rule is followed to select one or more parameters associated with the communication between the access point 102 and the wireless device 104a. For example, when the newest Wi-Fi protocol supported by the access point 102 is 802.11ax but the wireless device 104a supports an older 802.11ac protocol, the 802.11ac protocol is selected for the communication. In another example, when the access point 102 uses 4×4 antenna configuration but the wireless device 104a uses a 1×1 antenna configuration, the 1×1 antenna configuration is selected for the communication. In another example, when the access point 102 supports a channel frequency of up to 160 MHz but the wireless device 104a only supports 40 MHz, 40 MHz is selected for the communication. Additionally, it may be noted that radio conditions experienced by the wireless device 104a may also contribute to the maximum link speed 140 negotiated for communication between the access point 102 and the wireless device 104a. For example, the same wireless device 104a may achieve a maximum link speed 140 of 80 Mbps when placed in the same room as the wireless access point 102. However, the maximum link speed 140 may drop down to 25 Mbps when placed behind a wall (e.g., in different rooms).

Once, the access point 102 has determined the maximum link speed 140 between the access point 102 and the wireless device 104a, the access point 102 may determine a portion (e.g., percentage) of the total bandwidth 138 that is occupied by the wireless device 104a for a particular data transfer rate 142 between the access point 102 and wireless device 104. For example, when maximum determined link speed 140 for the wireless device 104a is 25 Mbps and the wireless device 104a requests a data transfer rate 142 of 15 Mbps, the access point 102 may determine the percentage of the total bandwidth 138 occupied by the wireless device 104a as (15/25)×100=60%. This means that a data transfer between the access point 102 and the wireless device 104a at 15 Mbps occupies 60% of the total bandwidth 138 supported by the access point 102.

In certain embodiments, the access point 102 may be configured to determine the maximum link speed 140 for each wireless device 104 in the wireless network and further determine a portion (e.g., percentage) of the total bandwidth 138 occupied or to be occupied by each wireless device 104 for a respective data transfer rate 142 requested by the wireless device 104.

When the access point 102 receives requests from several wireless devices 104 for data transfers at respective data transfer rates 142 requested by the wireless devices 104, the access point 102 may be configured to determine whether the bandwidth needed to service all received requests simultaneously may cause oversubscription of the total bandwidth 138 supported by the access point 102. For example, upon detecting that the access point 102 is to simultaneously transmit data to several wireless devices 104, the access point 102 may determine the overall bandwidth required to simultaneously transmit data to the wireless devices 104 at their respective requested data transfer rates 142. To determine the overall required bandwidth, the access point 102 may add the portions (e.g., percentages) of the total bandwidth 138 occupied or to be occupied by each wireless device 104. For example, when a first wireless device 104a is determined to occupy 60% of the total bandwidth 138 and a second wireless device 104b is determined to occupy 50% of the total bandwidth 138, the access point 102 may determine that an overall bandwidth of 60%+50%=110% is needed to simultaneously transmit data to both wireless devices 104a and 104b. When the overall bandwidth needed to transmit/receive data to/from all requesting wireless devices 104 exceeds 100%, the access point 102 determines that the total bandwidth 138 supported by the access point 102 is over subscribed. This means that the amount of bandwidth needed to simultaneously transfer data to the requesting wireless devices 104 exceeds the capacity of the access point 102.

In response to determining that the total bandwidth 138 is oversubscribed, the access point 102 may be configured to throttle down the data transfer rate 142 of one or more wireless devices 104 to bring the overall required bandwidth to transfer data to all requesting wireless devices 104 to be at least equal to or lower than the total bandwidth 138. The access point 102 may be configured to determine which one or more wireless devices 104 are to be throttled based on the maximum link speeds 140 supported by the wireless devices 104. In one embodiment, the access point 102 throttles the data transfer rate 142 of the wireless device 104 that supports the slowest maximum link speed 140 among all the wireless devices 104 that need service from the wireless access point 102. The access point 102 may continue to throttle the data transfer rate 142 of the wireless device 104 until the overall bandwidth needed to transfer data to/from all wireless devices 104 equals or drops lower than the total bandwidth 138.

In an alternative or additional embodiment, the access point 102 continuously (e.g., periodically or according to a pre-determined schedule) determines the portions of the total bandwidth 138 occupied by each of the wireless devices 104 and, if the total bandwidth 138 is oversubscribed, start throttling by a pre-determined rate the data transfer rate 142 of the wireless device 104 that supports the slowest maximum link speed 140.

In an additional or alternative embodiment, when the total bandwidth 138 is oversubscribed, the access point 102 compares the maximum link speed 140 supported by each wireless device 104 to a threshold 144 (e.g., threshold link speed). When the maximum link speed 140 supported by a particular wireless device 104 equals or is lower than the threshold 144, the access point 102 throttles the data transfer rate 142 of the particular wireless device to bring the overall required bandwidth to a value that is equal to or lower than the total bandwidth 138. In one embodiment, when none of the maximum link speeds 140 supported by the wireless devices 104 equal or are lower than the threshold 144, the access point 102 starts throttling the data transfer rates 142 of all the wireless devices 104 (e.g., by equal amounts) until the overall required bandwidth to a value that is equal to or lower than the total bandwidth 138.

In an alternative or additional embodiment, the access point 102 may also be configured to temporarily remove the wireless device 104 that supports the slowest maximum link speed 140 when throttling alone the wireless device 104 does not bring the overall required bandwidth to transfer data to/from all requesting wireless devices 104 to a value that equals or is lower than the total bandwidth 138. In one embodiment, removing a wireless device 104 may include stopping transfer data to/from the wireless device 104 and/or moving the data transfer to/from the wireless device 104 to a different channel. For example, a wireless device 104 may be moved from a 5 GHz channel to a 2.4 GHz channel. In other words, the wireless device 104 stops transmitting to/receiving from the wireless device 104 on the 5 GHz channel that is oversubscribed, and resumes the transmitting/receiving on the 2.4 GHz channel.

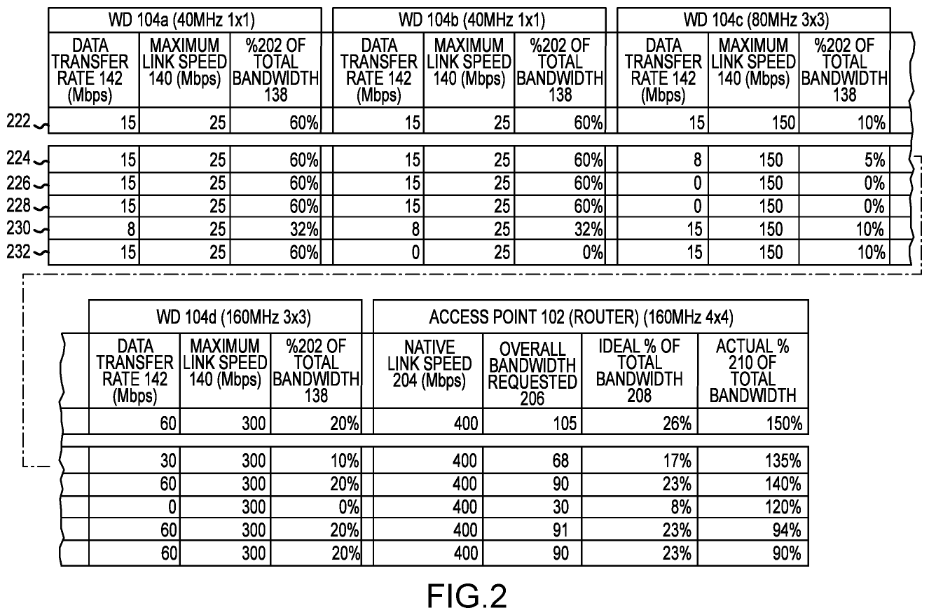

FIG. 2 illustrates an example distribution of bandwidth between wireless devices 104 by the access point 102, in accordance with one or more embodiments of the present disclosure. In the example table shown in FIG. 2, the access point 102 (e.g., a wireless router) is required to simultaneously transmit data to four different wireless devices shown as WD 104a, WD 104b, WD 104c, and WD 104d. For each of the four wireless devices 104a-104d, each row 222-232 of the table in FIG. 2 shows a current data transfer rate 142, the maximum link speed 140 that can be achieved between the access point 102 and the wireless device 104a-104d, and a percentage 202 of the total bandwidth 138 occupied by the wireless device 104a-104d given the current data transfer rate 142. Further, for the access point 102, each row 222-232 of the table in FIG. 2 shows a native link speed 204 of the access point 102, overall bandwidth 206 requested by all wireless devices 104a-104d, an ideal percentage 208 of the total bandwidth 138 occupied by all wireless devices 104a-104d if all wireless devices 104a-104d support the native link speed 204 of the access point 102, and an actual percentage 210 of the total bandwidth 138 occupied by all wireless devices 104a-104d.

The maximum link speed 140 that can be achieved between the access point 102 and the wireless device 104a-104d and the percentage 202 of the total bandwidth 138 occupied by the wireless device 104a-104d for a given current data transfer rate 142 may be determined as described in the above paragraphs. The native link speed 204 of the access point 102 is the maximum link speed supported by the access point 102. The access point 102 can generally communicate with a wireless device 104 at the native link speed 204 when the capabilities (e.g., wireless protocol, antenna configuration, channel frequency etc.) of the wireless device 104 match the respective capabilities of the access point 102 and the signal strength at the wireless device 104 is strong. However, in most cases, the maximum link speed 140 that can be actually achieved is lower than the native link speed 204 of the access point 102. The overall bandwidth 206 requested by all wireless devices 104a-104e may be determined as a sum of the individual current data transfer rates 142 of each wireless device 104a-104d. The ideal percentage 208 of the total bandwidth 138 occupied by all wireless devices 104a-104d represents the overall bandwidth that may be occupied by all wireless devices 104a-104d if all wireless devices 104a-104d supported the native link speed 204 of the access point 102. The ideal percentage 208 may be determined as (native link speed 204/overall bandwidth 206)×100. The actual percentage 210 of the total bandwidth 138 occupied by all wireless devices 104a-104d may be determined as described in the above paragraphs by adding the percentages 202 of the total bandwidth 138 occupied by each wireless device 104a-104d.

Referring to FIG. 2, row 222 of the table shows that the current data transfer rate 142 of each of the wireless devices 104a-104c is 15 Mbps and the current data transfer rate 142 of wireless device 104d is 60 Mbps. This means that the access point 102 is to transmit data to each of the wireless devices 104a-104c at 15 Mbps and is to transmit data to wireless device 104d at 60 Mbps. As shown, for the same current data transfer rate of 15 Mbps, each of WD 104a and WD 104b occupy 60% of the total bandwidth 138, but WD 104d occupies only 10% of the total bandwidth 138. Further, for a much faster current data transfer rate 142 of 60 Mbps, WD 104d occupies only 20% of the total bandwidth 138 which is one third of the bandwidths occupied by WDs 104a and 104b at a much lower data transfer rate 142 of 15 Mbps. This is because WD 104a and 104b which support maximum link speeds 140 of 25 Mbps each are much slower devices as compared to WDs 104d and 104e which support maximum link speeds 140 of 150 Mbps and 300 Mbps respectively. As shown, if the access point 102 were to transmit data to WDs 104a-104c at 15 Mbps each and transmit data to WD 104d at 60 Mbps, the actual percentage 210 of the total bandwidth 138 collectively occupied by all WDs 104a-104d is 150%, which means that the total bandwidth 138 is oversubscribed.

Row 224 shows that the current data transfer rates 142 for the faster WDs 104c and 104d have been throttled down to 8 Mbps and 30 Mbps respectively while the data transfer rates 142 for the slower WDs 104a and 104b have been maintained at 15 Mbps. However, even if the access point 102 were to transmit data to WDs 104a and 104b at 15 Mbps each and transmit data to WDs 104c and 104d at the throttled down 8 Mbps and 30 Mbps respectively, the actual percentage 210 of the total bandwidth 138 collectively occupied by all WDs 104a-104d is 135%, which means that the total bandwidth 138 is still oversubscribed.

Row 226 shows that WD 104c has been removed and the access point 102 transmits only to WDs 104a, 104b, and 104d at their original requested data transfer rate 142 of 15 Mbps, 15 Mbps and 60 Mbps respectively. However, even with WD 104c removed, the actual percentage 210 of the total bandwidth 138 collectively occupied by WDs 104a, 104b, and 104d is 140%, which means that the total bandwidth 138 is oversubscribed even with one faster WD 104c removed.

Row 228 shows that both faster WDs 104c and 104d have been removed and the access point 102 transmits only to WDs 104a and 104b at their original requested data transfer rate 142 of 15 Mbps. However, even with both faster WDs 104c and 104d removed, the actual percentage 210 of the total bandwidth 138 collectively occupied by slower WDs 104a and 104b alone is 120%, which means that the total bandwidth 138 is oversubscribed even when both faster WDs 104c and 104d are removed.

Thus, rows 224, 226 and 228 generally illustrate that certain slower devices (e.g., WD 104a, 104b) may occupy so much of the total bandwidth 138 that throttling down or even removing faster wireless devices 104 in the wireless network may not help with the oversubscription issue. However, determining which one or more wireless devices 104 to throttle or remove based on the maximum link speed 140, as described above, may help alleviate the oversubscription issue without affecting too many devices on the wireless network and thus improve overall user experience on the wireless network.

For example, row 230 shows that both slower wireless devices WDs 104a and 104b have been throttled down to 8 Mbps each while the data transfer rates 142 of the faster wireless devices WDs 104c and 104d are maintained at their original requested data transfer rates 142 of 15 Mbps and 60 Mbps respectively. As shown, this brings down the actual percentage 210 of the total bandwidth 138 occupied by all wireless devices WDs 104a-104d to 94%, thus alleviating the oversubscription issue.

Row 232 shows an alternative example in which one of the slower wireless devices WD 104b has been removed while the data transfer rates 142 of the remaining wireless devices WDs 104a, 104c, and 104d are maintained at their original requested data transfer rates 142 of 15 Mbps, 15 Mbps and 60 Mbps respectively. As shown, this brings down the actual percentage 210 of the total bandwidth 138 occupied by the remaining wireless devices WDs 104a, 104c, and 104d, to 90%, thus alleviating the oversubscription issue.

Thus, the examples in rows 230 and 232 show that throttling down or removing a slower wireless device (e.g., a device that supports a lower maximum link speed 140) is much more effective in alleviating the oversubscription issue as compared to throttling down or removing faster wireless devices. Further as lesser wireless devices are throttled down or removed, this improves the overall user experience on the wireless network.

FIG. 3 is a flowchart of an example method 300 for managing network bandwidth, in accordance with embodiments of the present disclosure. Method 300 may be performed by an access point 102 (e.g., wireless access point 102 such as a wireless network router) as shown in FIG. 1 and described above.

At operation 302, an access point system (e.g., wireless access point 102) detects that the access point system is to simultaneously transmit data to or receive data from a plurality of devices (e.g., wireless devices 104), wherein the access point system is configured to connect the devices (e.g., wireless devices 104) to a data network (e.g., data network 120). For example, each of the plurality of wireless devices 104 may simultaneously request data transfer from the access point 102 at respective data rates.

At operation 304, for each wireless device 104 of the plurality of wireless devices 104, the access point system (e.g., wireless access point 102) determines a maximum link speed 140 associated with the wireless device 104, wherein the maximum link speed 140 is an estimated maximum speed of data exchange that can be achieved between the wireless access point 102 and the wireless device 104.

As described above, the wireless access point 102 may be configured to determine a maximum link speed 140 that may be achieved between the access point 102 and a particular wireless device 104a. In certain embodiments, before actual data transfer takes place, the access point 102 and the wireless device 104a negotiate the maximum link speed 140 between the access point 102 and the a wireless device 104a. Different wireless devices 104 negotiate different maximum link speeds 140 with the wireless access point 102 depending on several parameters including, but not limited to, wireless protocol used by the wireless device, supported channel frequency, number of antennas, and/or radio conditions (e.g., signal strength from the access point 102) at the wireless device 104. As described above, a least common capability rule is followed to select one or more parameters associated with the communication between the access point 102 and a wireless device 104a. For example, when the newest Wi-Fi protocol supported by the access point 102 is 802.11ax but the wireless device 104a supports an older 802.11ac protocol, the 802.11ac protocol is selected for the communication. In another example, when the access point 102 uses 4×4 antenna configuration but the wireless device 104a uses a 1×1 antenna configuration, the 1×1 antenna configuration is selected for the communication. In another example, when the access point 102 supports a channel frequency of up to 160 MHz but the wireless device 104a only supports 40 MHz, 40 MHz is selected for the communication. Additionally, it may be noted that radio conditions experienced by the wireless device 104a may also contribute to the maximum link speed 140 negotiated for communication between the access point 102 and the wireless device 104a. For example, the same wireless device 104a may achieve a maximum link speed 140 of 80 Mbps when placed in the same room as the wireless access point 102. However, the maximum link speed 140 may drop down to 25 Mbps when placed behind a wall (e.g., in different rooms).

At operation 306, for each wireless device 104 of the plurality of wireless devices 104, the access point system (e.g., wireless access point 102) determines, based at least on the maximum link speed 140 associated with the wireless device 104, a portion of a total bandwidth 138 supported by the access point system required to transmit data to or receive data from the wireless device 104 at a data transfer rate 142 associated with transmitting data to or receiving data from the wireless device 104. The data transfer rate 142 associated with transmitting data to or receiving data from the wireless device 104 may be a data transfer rate 142 requested by the wireless device 104.

As described above, once, the access point 102 has determined the maximum link speed 140 between the access point 102 and the wireless device 104a, the access point 102 may determine a portion (e.g., percentage) of the total bandwidth 138 that is occupied by the wireless device 104a for a particular data transfer rate 142 between the access point 102 and wireless device 104. For example, when maximum determined link speed 140 for the wireless device 104a is 25 Mbps and the wireless device 104a requests a data transfer rate 142 of 15 Mbps, the access point 102 may determine the percentage of the total bandwidth 138 occupied by the wireless device 104a as (15/25)×100=60%. This means that a data transfer between the access point 102 and the wireless device 104a at 15 Mbps occupies 60% of the total bandwidth 138 supported by the access point 102.

In certain embodiments, the access point 102 may be configured to determine the maximum link speed 140 for each wireless device 104 in the wireless network and further determine a portion (e.g., percentage) of the total bandwidth 138 occupied or to be occupied by each wireless device 104 for a respective data transfer rate 142 requested by the wireless device 104.

At operation 308, the access point system (e.g., wireless access point 102) determines that a sum of the portions of the total bandwidth 138 required by the plurality of wireless devices 104 exceeds the total bandwidth 138 supported by the access point system.

As described above, when the access point 102 receives requests from several wireless devices 104 for data transfers at respective data transfer rates 142 requested by the wireless devices 104, the access point 102 may be configured to determine whether the bandwidth needed to service all received requests simultaneously may cause oversubscription of the total bandwidth 138 supported by the access point 102. For example, upon detecting that the access point 102 is to simultaneously transmit data to several wireless devices 104, the access point 102 may determine the overall bandwidth required to simultaneously transmit data to the wireless devices 104 at their respective requested data transfer rates 142. To determine the overall required bandwidth, the access point 102 may add the portions (e.g., percentages) of the total bandwidth 138 occupied or to be occupied by each wireless device 104. For example, when a first wireless device 104a is determined to occupy 60% of the total bandwidth 138 and a second wireless device 104b is determined to occupy 50% of the total bandwidth 138, the access point 102 may determine that an overall bandwidth of 60%+50%=110% is needed to simultaneously transmit data to both wireless devices 104a and 104b. When the overall bandwidth needed to transmit/receive data to/from all requesting wireless devices 104 exceeds 100%, the access point 102 determines that the total bandwidth 138 supported by the access point 102 is oversubscribed. This means that the amount of bandwidth needed to simultaneously transfer data to the requesting wireless devices 104 exceeds the capacity of the access point 102.

At operation 310, the access point system (e.g., wireless access point 102) determines that a first maximum link speed 140 associated with a first wireless device (e.g., first wireless device 104a) of the plurality of wireless devices 104 is a slowest maximum link speed 140 of the maximum link speeds 140 associated with the plurality of wireless devices 104.

At operation 312, in response to determining that the first maximum link speed 140 associated with the first wireless device 104a is the slowest maximum link speed 140, the access point system (e.g., wireless access point 102) throttles a first data transfer rate 142 associated with transmitting data to or receiving data from the first wireless device 104a to reduce a first portion of the total bandwidth required to transmit data to or receive data from the first wireless device at the first data transfer rate 142.

As described above, in response to determining that the total bandwidth 138 is oversubscribed, the access point 102 may be configured to throttle down the data transfer rate 142 of one or more wireless devices 104 to bring the overall required bandwidth to transfer data to all requesting wireless devices 104 to be at least equal to or lower than the total bandwidth 138. The access point 102 may be configured to determine which one or more wireless devices 104 are to be throttled based on the maximum link speeds 140 supported by the wireless devices 104. In one embodiment, the access point 102 throttles the data transfer rate 142 of the wireless device 104 that supports the slowest maximum link speed 140 among all the wireless devices 104 that need service from the wireless access point 102. The access point 102 may continue to throttle the data transfer rate 142 of the wireless device 104 until the overall bandwidth needed to transfer data to/from all wireless devices 104 equals or drops lower than the total bandwidth 138.

At operation 314, the access point system (wireless access point 102) transmits data to or receives data from the first wireless device 104a at the throttled first data transfer rate 142 and transmits data to or receives data from the remaining wireless devices 104a of the plurality of the wireless devices 104 at respective data rates requested by the remaining wireless devices 104.

It may be noted that the access point (e.g., wireless access point 102) may be configured to repeat 302-318 whenever multiple devices (e.g., wireless devices 104) simultaneously request service from the access point.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. An access point system, comprising:
a memory; and
a processor communicatively coupled to the memory and configured to:
detect that the access point system is to simultaneously transmit data to or receive data from a plurality of devices, wherein the access point system is configured to connect the devices to a data network;
for each device of the plurality of devices:
determine a maximum link speed associated with the device, wherein the maximum link speed is an estimated maximum speed of data exchange that can be achieved between the access point system and the device; and
determine, based at least on the maximum link speed, a portion of a total bandwidth supported by the access point system required to transmit data to or receive data from the device at a data rate associated with transmitting data to or receiving data from the device;
determine that a sum of the portions of the total bandwidth required by the plurality of devices exceeds the total bandwidth supported by the access point system;
determine that a first maximum link speed associated with a first device of the plurality of devices is a slowest maximum link speed of the maximum link speeds associated with the plurality of the devices;
in response to determining that the first maximum link speed associated with the first device is the slowest maximum link speed, throttle a first data rate associated with transmitting data to or receiving data from the first device to reduce a first portion of the total bandwidth required to transmit data to or receive data from the first device at the first data rate; and
transmit data to or receive data from the first device at the throttled first data rate and transmit data to or receive data from remaining device of the plurality of the devices at respective data rates requested by the remaining devices.

2. The access point system of claim 1, wherein the processor is further configured to:
determine the first portion of the total bandwidth supported by the access point system and required to transmit data to or receive data from the first device at the first data rate, based on the first data rate and the first maximum link speed.

3. The access point system of claim 2, wherein the processor is further configured to:
determine the first portion of the total bandwidth by dividing the first data rate by the first maximum link speed.

4. The access point system of claim 2, wherein:
the first maximum link speed associated with the first device is based at least on a communication protocol supported by the first device, a number of antennas used by the first device and a channel bandwidth supported by the first device.

5. The access point system of claim 1, wherein the processor is further configured to:
determine that throttling the first data rate associated with transmitting data to or receive data from the first device does not bring a bandwidth required to simultaneously transmit data to or receive data from the plurality of devices to be equal to or lower than the total bandwidth supported by the access point system; and
in response to determining that throttling the first data rate associated with transmitting data to or receive data from the first device does not bring the bandwidth required to simultaneously transmit data to or receive data from the plurality of devices to be equal to or lower than the total bandwidth supported by the access point system, stop transmitting data to or receive data from the first device and transmit data to or receive data from the remaining devices only.

6. The access point system of claim 5, wherein the processor is configured to stop transmitting data to or receiving data from the first device by:
stopping to transmit data to or receive data from the first device on a first channel on which the access point system is to simultaneously transmit data to or receive data from the plurality of devices; and
starting to transmit the data to or receive the data from the first device on a second channel different from the first channel.

7. The access point system of claim 1, wherein the processor is further configured to throttle the first data rate associated with transmitting data to or receiving data from the first device to reduce the first portion of the total bandwidth required to transmit data to or receive data from the first device at the first data rate, such that the reduced first portion and remaining portions of the total bandwidth associated with remaining devices of the plurality of devices add up to be equal to or lower than the total bandwidth supported by the access point system.

8. A method for managing bandwidth in a network, comprising:
detecting that an access point system is to simultaneously transmit data to or receive data from a plurality of devices, wherein the access point system is configured to connect the devices to a data network;
for each device of the plurality of devices:
determining a maximum link speed associated with the device, wherein the maximum link speed is an estimated maximum speed of data exchange that can be achieved between the access point system and the device; and
determining, based at least on the maximum link speed, a portion of a total bandwidth supported by the access point system required to transmit data to or receive data from the device at a data rate associated with transmitting data to or receiving data from the device;
determining that a sum of the portions of the total bandwidth required by the plurality of devices exceeds the total bandwidth supported by the access point system;
determining that a first maximum link speed associated with a first device of the plurality of devices is a slowest maximum link speed of the maximum link speeds associated with the plurality of the devices;
in response to determining that the first maximum link speed associated with the first device is the slowest maximum link speed, throttling a first data rate associated with transmitting data to or receiving data from the first device to reduce a first portion of the total bandwidth required to transmit data to or receive data from the first device at the first data rate; and
transmitting data to or receive data from the first device at the throttled first data rate and transmit data to or receive data from remaining device of the plurality of the devices at respective data rates requested by the remaining devices.

9. The method of claim 8, further comprising:
determining the first portion of the total bandwidth supported by the access point system and required to transmit data to or receive data from the first device at the first data rate, based on the first data rate and the first maximum link speed.

10. The method of claim 9, further comprising:
determining the first portion of the total bandwidth by dividing the first data rate by the first maximum link speed.

11. The method of claim 9, wherein:
the first maximum link speed associated with the first device is based at least on a communication protocol supported by the first device, a number of antennas used by the first device and a channel bandwidth supported by the first device.

12. The method of claim 8, further comprising:
determining that throttling the first data rate associated with transmitting data to or receive data from the first device does not bring a bandwidth required to simultaneously transmit data to or receive data from the plurality of devices to be equal to or lower than the total bandwidth supported by the access point system; and
in response to determining that throttling the first data rate associated with transmitting data to or receive data from the first device does not bring the bandwidth required to simultaneously transmit data to or receive data from the plurality of devices to be equal to or lower than the total bandwidth supported by the access point system, stopping to transmit data to or receive data from the first device and transmit data to or receive data from the remaining devices only.

13. The method of claim 12, wherein stopping to transmit data to or receive data from the first device comprises:
stopping to transmit data to or receive data from the first device on a first channel on which the access point system is to simultaneously transmit data to or receive data from the plurality of devices; and
starting to transmit the data to or receive the data from the first device on a second channel different from the first channel.

14. The method of claim 8, further comprising throttling the first data rate associated with transmitting data to or receiving data from the first device to reduce the first portion of the total bandwidth required to transmit data to or receive data from the first device at the first data rate, such that the reduced first portion and remaining portions of the total bandwidth associated with remaining devices of the plurality of devices add up to be equal to or lower than the total bandwidth supported by the access point system.

15. A non-transitory computer-readable medium storing instructions that when executed by a processor causes the processor to:
detect that an access point system is to simultaneously transmit data to or receive data from a plurality of devices, wherein the access point system is configured to connect the devices to a data network;
for each device of the plurality of devices:
determine a maximum link speed associated with the device, wherein the maximum link speed is an estimated maximum speed of data exchange that can be achieved between the access point system and the device; and
determine, based at least on the maximum link speed, a portion of a total bandwidth supported by the access point system required to transmit data to or receive data from the device at a data rate associated with transmitting data to or receiving data from the device;
determine that a sum of the portions of the total bandwidth required by the plurality of devices exceeds the total bandwidth supported by the access point system;
determine that a first maximum link speed associated with a first device of the plurality of devices is a slowest maximum link speed of the maximum link speeds associated with the plurality of the devices;
in response to determining that the first maximum link speed associated with the first device is the slowest maximum link speed, throttle a first data rate associated with transmitting data to or receiving data from the first device to reduce a first portion of the total bandwidth required to transmit data to or receive data from the first device at the first data rate; and
transmit data to or receive data from the first device at the throttled first data rate and transmit data to or receive data from remaining device of the plurality of the devices at respective data rates requested by the remaining devices.

16. The non-transitory computer-readable medium of claim 15, wherein the instructions further cause the processor to:
determine the first portion of the total bandwidth supported by the access point system and required to transmit data to or receive data from the first device at the first data rate, based on the first data rate and the first maximum link speed.

17. The non-transitory computer-readable medium of claim 16, wherein the instructions further cause the processor to:
determine the first portion of the total bandwidth by dividing the first data rate by the first maximum link speed.

18. The non-transitory computer-readable medium of claim 16, wherein:
the first maximum link speed associated with the first device is based at least on a communication protocol supported by the first device, a number of antennas used by the first device and a channel bandwidth supported by the first device.

19. The non-transitory computer-readable medium of claim 15, wherein the instructions further cause the processor to:
determine that throttling the first data rate associated with transmitting data to or receive data from the first device does not bring a bandwidth required to simultaneously transmit data to or receive data from the plurality of devices to be equal to or lower than the total bandwidth supported by the access point system; and
in response to determining that throttling the first data rate associated with transmitting data to or receive data from the first device does not bring the bandwidth required to simultaneously transmit data to or receive data from the plurality of devices to be equal to or lower than the total bandwidth supported by the access point system, stop transmitting data to or receive data from the first device and transmit data to or receive data from the remaining devices only.

20. The non-transitory computer-readable medium of claim 19, wherein stopping to transmit data to or receive data from the first device comprises:
stopping to transmit data to or receive data from the first device on a first channel on which the access point system is to simultaneously transmit data to or receive data from the plurality of devices; and
starting to transmit the data to or receive the data from the first device on a second channel different from the first channel.
